(19) United States
(12) Patent Application Publication
(10) Pub. No.: US 2025/0321965 A1
(43) Pub. Date: Oct. 16, 2025

(54) COMPUTING SYSTEM, HARDWARE ACCELERATOR DEVICE, AND METHOD FOR DEEP LEARNING INFERENCE

(71) Applicant: Mobilint, Inc., Seoul (KR)

(72) Inventors: Dongjoo SHIN, Guri-si (KR); Jongjun PARK, Seoul (KR); Jisung KIM, Seoul (KR)

(73) Assignee: Mobilint, Inc., Seoul (KR)

(21) Appl. No.: 19/247,845

(22) Filed: Jun. 24, 2025

Related U.S. Application Data
(63) Continuation of application No. PCT/KR2022/021267, filed on Dec. 26, 2022.

(30) Foreign Application Priority Data
Dec. 26, 2022 (KR) 10-2022-0183917

(51) Int. Cl. G06F 16/2453

(52) U.S. Cl. CPC G06F 16/24542; G06F 16/24532

(57) ABSTRACT

Disclosed are a computing system, hardware accelerator device, and method for deep learning inference. The accelerator device includes input storage configured to store input query data, an accelerator configured to output inference data, which is the result of a deep learning operation on the input query data, and output storage configured to store the inference data. The input storage stores subsequent query data, input from a host processor, in advance during the deep learning operation on the input query data in the accelerator.

### CROSS-REFERENCE TO RELATED APPLICATIONS

The present application is a continuation of International Patent Application No. PCT/KR2022/021267, filed on Dec. 26, 2022, which is based upon and claims the benefit of priority to Korean Patent Application No. 10-2022-0183917 filed on Dec. 26, 2022. The disclosures of the above-listed applications are hereby incorporated by reference herein in their entirety.

### BACKGROUND

Embodiments of the inventive concept described herein relate to a computing system, hardware accelerator device, and method for deep learning inference.

Recently, with the development of artificial neural network (ANN) algorithm technology, research on extracting valid data by analyzing input data using an ANN is actively being conducted in various fields.

In the past, ANN operations have been mainly performed on central processing units (CPUs), but there is a problem that execution time is excessively long due to the excessive amount of computation. In order to overcome this problem, research is being conducted to process large amounts of data at high speed by using hardware accelerator devices such as graphics processing units (GPUs).

In general, when a hardware accelerator device is implemented as a peripheral device, it takes a specific amount of time to move data. There is a problem that this data movement time acts as a throughput deterioration factor in the evaluation of inference throughput.

### SUMMARY

The inventive concept provides a computing system, hardware accelerator device, and method for deep learning inference.

The technical objects of the inventive concept are not limited to the above-mentioned ones, and the other unmentioned technical objects will become apparent to those skilled in the art from the following description.

In accordance with an aspect of the inventive concept, there is provided a hardware accelerator device comprising input storage configured to store query data input from a host processor, an accelerator configured to perform a deep learning operation on the query data stored in the input storage, and to output inference data, which is a result of the deep learning operation, output storage configured to store the inference data, and a status register configured to determine whether previous query data is required in a deep learning operation during the deep learning operation on the previous query data, and to generate a flag, indicating a state in which new query data can be input, when the previous query data is no longer required in the deep learning operation, wherein the input storage receives the new query data from the host processor that recognizes the flag during the deep learning operation on the previous query data, replaces the previous query data with the new query data, and stores the new query data in advance.

In accordance with another aspect of the inventive concept, there is provided a computing system comprising a host processor configured to request a deep learning operation on query data, a hardware accelerator device for deep learning inference configured to receive the query data from the host processor, to perform the deep learning operation on the query data, and to output inference data, which is a result of the deep learning operation, and memory configured to store the query data and the inference data, wherein the hardware accelerator device for deep learning inference comprises, input storage configured to store the query data input from the host processor, an accelerator configured to perform the deep learning operation on the query data stored in the input storage, and to output the inference data, which is the result of the deep learning operation, output storage configured to store the inference data, and a status register configured to determine whether previous query data is required in a deep learning operation during the deep learning operation on the previous query data, and to generate a flag, indicating a state in which new query data can be input, when the previous query data is no longer required in the deep learning operation, and wherein the input storage receives the new query data from the host processor that recognizes the flag during the deep learning operation on the previous query data, replaces the previous query data with the new query data, and stores the new query data in advance.

In accordance with another aspect of the inventive concept, there is provided a method of controlling a hardware accelerator device for deep learning inference, the method comprising storing query data, input from a host processor, in input storage, performing a deep learning operation on the query data stored in the input storage, determining whether the query data is required in the deep learning operation during the deep learning operation on the query data, generating a flag, indicating a state in which new query data can be input, when the query data is no longer required in the deep learning operation, during the deep learning operation, receiving new query data from the host processor that recognizes the flag, during the deep learning operation, replacing the query data with the new query data and storing the new query data in advance in the input storage, outputting inference data, which is a result of the deep learning operation on the query data, and as the inference data, which is the result of the deep learning operation on the query data, is output, performing a deep learning operation on the new query data stored in advance.

The other detailed items of the inventive concept are described and illustrated in the specification and the drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram of a computing system according to one embodiment of the present invention;

FIG. 2 is a block diagram of a hardware accelerator device for deep learning inference according to one embodiment of the present invention;

FIG. 3 is a diagram illustrating the throughput of an accelerator with latencies taken into consideration;

FIG. 4 is a diagram illustrating the throughput of the accelerator with latencies taken into consideration, which is illustrated in FIG. 3, in more detail; and

FIG. 5 is a flowchart of a method of controlling a hardware accelerator device for deep learning inference according to one embodiment of the present invention.

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals denote the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings.

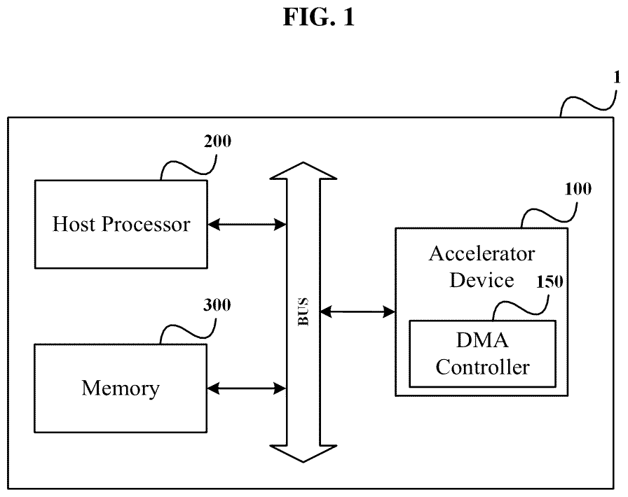

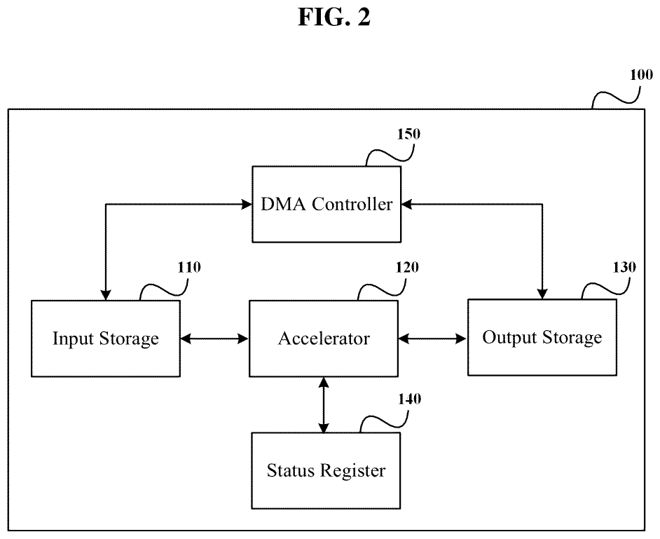

FIG. 1 is a block diagram of a computing system 1 according to one embodiment of the present invention. FIG. 2 is a block diagram of a hardware accelerator device for deep learning inference according to one embodiment of the present invention.

The computing system 1 according to the present embodiment includes a host processor 200, a hardware accelerator device 100 for deep learning inference (hereinafter referred to as the “accelerator device 100”), and memory 300. In this case, the accelerator device 100, the host processor 200, and the memory 300 are connected via a bus.

Furthermore, a direct memory access (DMA) controller 150 is implemented in a form that is included in the accelerator device 100. Alternatively, the DMA controller 150 may also be implemented in a form that is independent of the accelerator device 100 and directly connected to the bus.

The host processor 200 controls the operations of individual components included in the computing system 1. As an example, the host processor 200 may be a central processing unit (CPU). The host processor 200 requests a deep learning operation on query data from the accelerator device 100. An example of such a request to process query data may be a request to cause the accelerator device 100 to perform a deep learning operation for object recognition, voice recognition, interpretation or translation service, image processing, or the like and output inference data, which is the result of the operation.

The memory 300 stores input data input to a deep learning model and inference data output from the deep learning model. Furthermore, the memory 300 may store data required for data processing.

Referring to FIG. 2, the accelerator device 100 according to one embodiment of the present invention includes input storage 110, an accelerator 120, output storage 130, a status register 140, and the DMA controller 150.

In this case, the accelerator device 100 may include a graphics processing unit (GPU) or a neural processing unit (NPU), or may include a field programmable gate array (FPGA) or an application-specific integrated circuit (ASIC).

The input storage 110 stores input query data in response to a request from the host processor 200. The output storage 130 stores inference data, which is the result of a deep learning operation.

The accelerator 120 corresponds to a type of core that performs deep learning operations, and the status register 140 stores a flag, indicating a state in which subsequent query data can be input, in the input storage 110.

The DMA controller 150 is connected to the input storage 110 or the output storage 130, and provides direct data transmission between the accelerator device 100 and the memory 300.

In this case, the input storage 110 does not perform the function of a buffer. That is, the input storage 110 is characterized by not including an additional buffer for the temporary storage of query data. Furthermore, one embodiment of the present invention is characterized by not implementing a buffer for the temporary storage of query data in a path between the host processor 200 and the accelerator device 100.

In the case of the conventional technology, it may be possible to provide a buffer and store all the query data, input from the host processor 200, in the buffer. The present invention targets the accelerator device 100 that does not have a buffer, and has a distinct difference in configuration from the conventional technology that has a buffer.

One embodiment of the present invention may increase the number of PE-arrays by securing a design area by not having a buffer. Through this, the throughput of the deep learning operation of the accelerator device 100 may be improved. Based on the structure that enables such an improvement in throughput, one embodiment of the present invention may process query data.

Meanwhile, deep learning operations are performed while propagating, so that initially input query data is not used from a specific time. That is, when operations are performed on respective layers connected from the input layer of the deep learning model up to the output layer thereof, the result of an operation in a previous layer generally only affects an operation in a subsequent layer, but does not affect the subsequent layer.

Based on the above characteristics of deep learning operations, one embodiment of the present invention allows the host processor 200 to recognize that subsequent query data can be input through a flag at the time when previous query data is no longer required in the deep learning operation process of the accelerator 120 in the state in which the input storage 110 stores input query data. In this case, the recognition of the flag may be done in such a manner that the accelerator device 100 proactively transmits a flag-related signal to the host processor 200 so that the host processor 200 can recognize that subsequent query data can be input, or in such a manner that the host processor 200 can recognize whether subsequent query data can be input through an operation of directly reading a flag written to the status register 140 of the accelerator device 100.

Due to the recognition of the flag by the host processor 200, when the host processor 200 inputs new subsequent query data, the previous query data stored in the input storage 110 is replaced with the newly input subsequent query data, and the input storage 110 stores the replaced subsequent query data in advance.

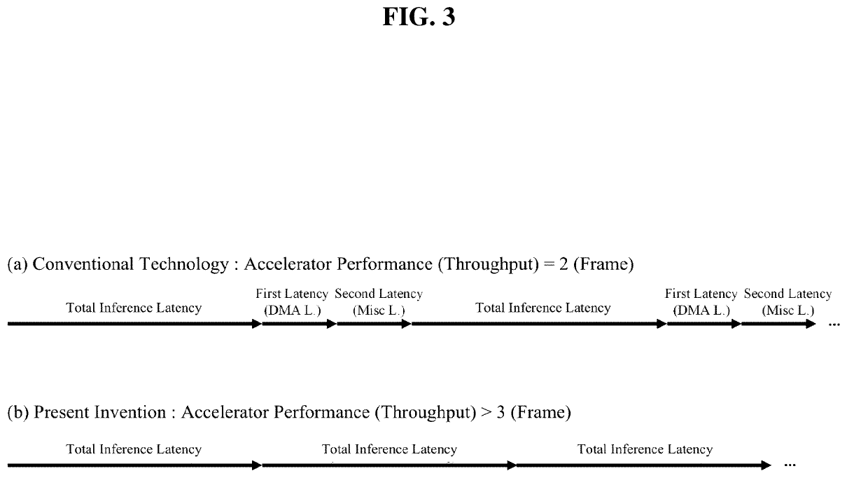

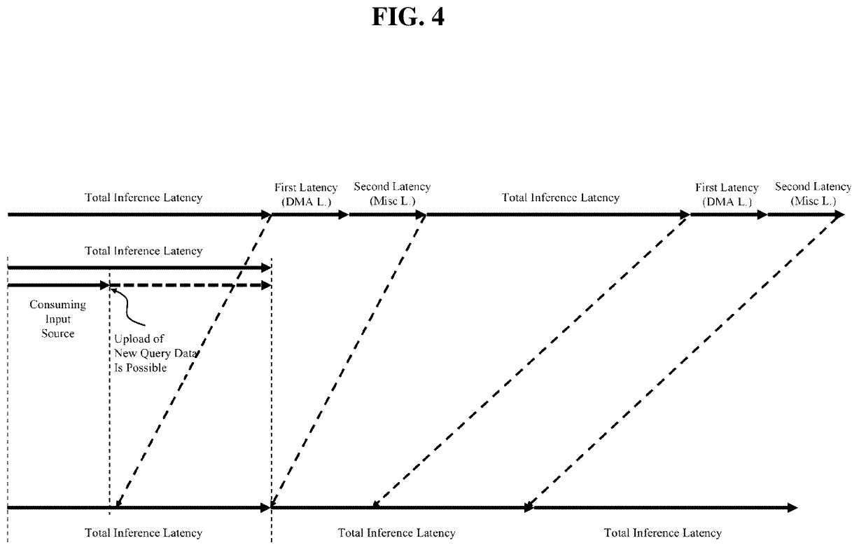

FIG. 3 is a diagram illustrating the throughput of the accelerator with latencies taken into consideration. FIG. 4 is a diagram illustrating the throughput of the accelerator with latencies taken into consideration, which is illustrated in FIG. 3, in more detail.

FIG. 3 is based on the processing of image data, and the computational throughput of the accelerator 120 is expressed in units of frames. In this case, the computational throughput of the accelerator 120 is determined by the number of pieces of query data processed per unit time (sec).

First, referring to FIG. 3(a), which illustrates the conventional technology, after the inference of the deep learning model for input query data has been completed, the processing of one piece of query data is completed only after the first latency (DMA L.) attributable to the direct memory access and the second latency (Misc L.) attributable to the branch delay due to the system structure. Furthermore, the conventional technology may receive subsequent query data only after the processing of one piece of query data has been completed.

In contrast, in the case of FIG. 3(b), which is an embodiment of the present invention, three or more pieces of query data may be processed during the time it takes to process two pieces of query data in the conventional technology. In this case, although three or more pieces of query data are illustrated as being processed in the case of the example shown in FIG. 3(b), the results may vary depending on the content, complexity, and/or the like of the deep learning operation.

Referring to FIG. 4 to describe FIG. 3 in more detail, in the conventional technology, in the process of receiving one piece of query data and outputting inference data, after the predetermined time required to receive query data, the time required to perform a deep learning operation on the query data and output inference data, and the first and second latencies have elapsed, subsequent query data is received and then a deep learning operation is performed.

Accordingly, in the conventional technology, when a deep learning operation is completed, it is impossible to immediately perform a deep learning operation on subsequently requested query data, and a problem arises in that a latency of a considerable amount of time occurs until, after the completion of a deep learning operation on previous query data, the host processor 200 requests subsequent query data from the accelerator device 100 and then the subsequent query data is transmitted and input.

In contrast, in the process of receiving one piece of query data and outputting inference data, the accelerator 120 according to one embodiment of the present invention enables the input of subsequent query data in advance at the time when input query data is no longer required during a deep learning operation after the predetermined time required to receive the query data has elapsed and before the time required to perform a deep learning operation on the previous query data and output inference data elapses, thereby minimizing the latency between the inference on the previous query data and the inference on the subsequent query data.

That is, one embodiment of the present invention allows a predetermined process for the input storage 110 to receive subsequent query data to be performed in parallel with a process in which the accelerator 120 performs a deep learning operation on previous query data. As a result, the number of pieces of query data processed by the accelerator 120 per unit time is increased, so that the throughput of the accelerator 120 can be expected to be improved.

In this case, the status register may store a flag indicating that the input of subsequent query data to the input storage 110 is possible after the time when previous query data is not required in a deep learning operation in the accelerator 120. The host processor 200 may recognize that the input of subsequent query data requiring a deep learning operation is possible by recognizing the flag provided through the accelerator device 100.

Meanwhile, when the accelerator 120 completes a deep learning operation for one piece of query data and outputs inference data, it performs a deep learning operation on subsequent query data stored in the input storage 100. However, the input storage 110 may replace previously stored previous query data with subsequent query data during the deep learning operation for the previous query data. Accordingly, when the deep learning operation for the previous query data is completed, the accelerator 120 may perform a deep learning operation on the subsequent query data immediately without having to wait for the time it takes for the subsequent query data to be transmitted to the input storage 110.

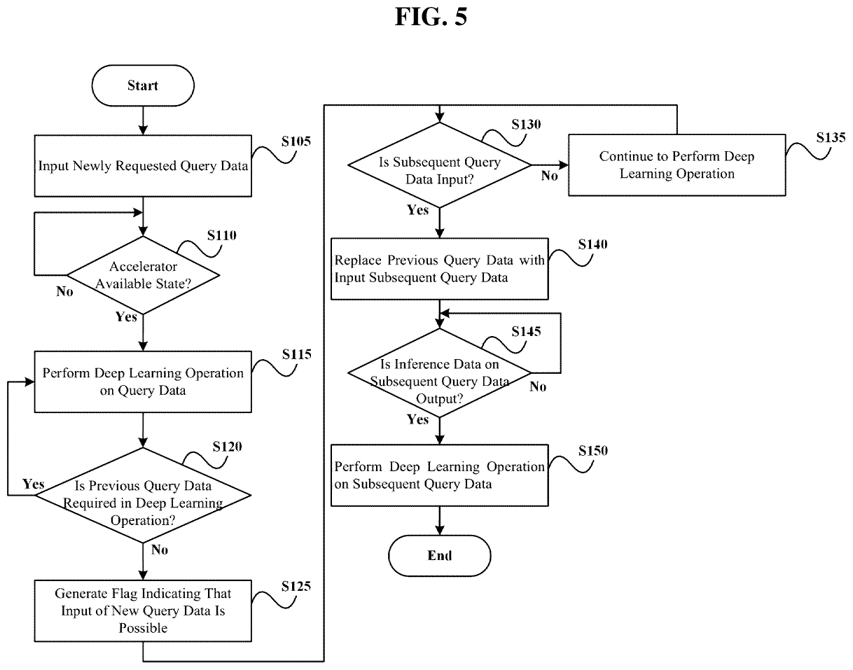

A method of controlling a hardware accelerator device for deep learning inference according to one embodiment of the present invention will be described below with reference to FIG. 5.

FIG. 5 is a flowchart of a method of controlling a hardware accelerator device for deep learning inference according to one embodiment of the present invention.

The control method according to one embodiment of the present invention first receives requested query data from the host processor 200 and stores it in the input storage 110 in step S105.

Next, when the accelerator 120 is in an available state, i.e., a state where the accelerator 120 can perform a deep learning operation (“Yes” in step S110), it performs a deep learning operation on the input query data in step S115. In contrast, when the accelerator 120 is not in an available state, it waits until the accelerator 120 enters an available state (“No” in step S110).

Next, it is determined whether the query data stored in the input storage 110 is no longer required in the deep learning operation during the deep learning operation in step S120. When it is determined that the deep learning operation process no longer requires the previous query data (“No” in step S120), a flag indicating that new query data can be stored in the status register 140 is generated in step S125. In contrast, when the deep learning operation process still requires the previous query data, no flag is generated (“Yes” in step S120).

As this flag is generated, the host processor 200 may recognize the flag through a predetermined method, and may transmit new query data requiring a deep learning operation to the accelerator device 100 when there is the new query data requiring a deep learning operation. When the accelerator device 100 receives new subsequent query data (“Yes” in step S130), it replaces the previous query data stored in the input storage 110 with the subsequent query data, and stores the subsequent query data in advance in step S140. In contrast, when there is no request for a deep learning operation for the subsequent query data from the host processor 200, the accelerator device 100 continues to perform the deep learning operation that has been previously performed in step S135.

Meanwhile, the deep learning operation of the accelerator 120 is continuously performed in parallel while steps S120 to S140 are being performed. When the deep learning operation corresponding to the previous query data is completed and inference data is output (“Yes” in step S145), the accelerator 120 enters an available state, and may perform a deep learning operation for the subsequent query data stored in the input storage 110 immediately without waiting for an input process for the subsequent query data in step S150. In contrast, when the inference data for the previous query data has not yet been output, the deep learning operation is continuously performed (“No” in step S145). Since the accelerator 120 is not in an available state, the subsequent query data waits in the input storage 110 until the accelerator 120 enters an available state.

Meanwhile, in the foregoing description, the logic for performing steps S110 to S150 may be located inside the accelerator 120. Furthermore, steps S110 to S150 may be further divided into additional steps or combined into fewer steps depending on the implementation of the present invention. Furthermore, some steps may be omitted as needed, and the order of the steps may be changed. Moreover, even omitted ones of the descriptions given in conjunction with FIGS. 1 to 4 may also be applied to the control method of FIG. 5.

The method of controlling a hardware accelerator device for deep learning inference according to one embodiment of the present invention described above may be implemented as a program (or an application) to be executed in combination with a computer, which is hardware, and may be stored in a medium.

In some embodiments, the above-discussed method of FIG. 5, according to this disclosure, is implemented in the form of program being readable through a variety of computer means and be recorded in any non-transitory computer-readable medium. Here, this medium, in some embodiments, contains, alone or in combination, program instructions, data files, data structures, and the like. These program instructions recorded in the medium are, in some embodiments, specially designed and constructed for this disclosure or known to persons in the field of computer software. For example, the medium includes hardware devices specially configured to store and execute program instructions, including magnetic media such as a hard disk, a floppy disk and a magnetic tape, optical media such as CD-ROM (Compact Disk Read Only Memory) and DVD (Digital Video Disk), magneto-optical media such as floptical disk, ROM, RAM (Random Access Memory), and flash memory. Program instructions include, in some embodiments, machine language codes made by a compiler compiler and high-level language codes executable in a computer using an interpreter or the like. These hardware devices are, in some embodiments, configured to operating as one or more of software to perform the operation of this disclosure, and vice versa.

A computer program (also known as a program, software, software application, script, or code) for the above-discussed method of FIG. 5 according to this disclosure is, in some embodiments, written in a programming language, including compiled or interpreted languages, or declarative or procedural languages. A computer program includes, in some embodiments, a unit suitable for use in a computing environment, including as a stand-alone program, a module, a component, or a subroutine. A computer program is or is not, in some embodiments, correspond to a file in a file system. A program is, in some embodiments, stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program is, in some embodiments, deployed to be executed on one or more computer processors located locally at one site or distributed across multiple remote sites and interconnected by a communication network.

According to the disclosed embodiment, an advantage arises in that the number of pieces of query data processed in the accelerator per unit time can be increased compared to the conventional technology through a structure that allows the new input of subsequent query data immediately at the time when previous query data is no longer required during a deep learning operation in the accelerator.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. A hardware accelerator device for deep learning inference, the hardware accelerator device comprising:
input storage configured to store query data input from a host processor;
an accelerator configured to perform a deep learning operation on the query data stored in the input storage, and to output inference data, which is a result of the deep learning operation;
output storage configured to store the inference data; and
a status register configured to determine whether previous query data is required in a deep learning operation during the deep learning operation on the previous query data, and to generate a flag, indicating a state in which new query data can be input, when the previous query data is no longer required in the deep learning operation,
wherein the input storage receives the new query data from the host processor that recognizes the flag during the deep learning operation on the previous query data, replaces the previous query data with the new query data, and stores the new query data in advance.

2. The hardware accelerator device of claim 1, wherein a buffer configured to temporarily store the query data is neither included in the input storage nor located between the host processor and the accelerator device.

3. The hardware accelerator device of claim 1, wherein a process in which the input storage receives the new query data is performed in parallel with a process in which the accelerator performs the deep learning operation on the previous query data.

4. The hardware accelerator device of claim 3, wherein the status register stores the flag indicating that input of the new query data to the input storage is possible after a time when the deep learning operation on the previous query data does not require the previous query data.

5. The hardware accelerator device of claim 4, wherein, when the accelerator outputs inference data, which is a result of the deep learning operation on the previous query data, it performs a deep learning operation on the new query data previously stored in the input storage.

6. The hardware accelerator device of claim 1, further comprising a direct memory access (DMA) controller connected to the input storage or the output storage.

7. The hardware accelerator device of claim 1, wherein the deep learning operation is a propagation method in which initially input query data is not used from a specific time.

8. A computing system comprising:
a host processor configured to request a deep learning operation on query data;
a hardware accelerator device for deep learning inference configured to receive the query data from the host processor, to perform the deep learning operation on the query data, and to output inference data, which is a result of the deep learning operation; and
memory configured to store the query data and the inference data,
wherein the hardware accelerator device for deep learning inference comprises:
input storage configured to store the query data input from the host processor;
an accelerator configured to perform the deep learning operation on the query data stored in the input storage, and to output the inference data, which is the result of the deep learning operation;
output storage configured to store the inference data; and
a status register configured to determine whether previous query data is required in a deep learning operation during the deep learning operation on the previous query data, and to generate a flag, indicating a state in which new query data can be input, when the previous query data is no longer required in the deep learning operation, and
wherein the input storage receives the new query data from the host processor that recognizes the flag during the deep learning operation on the previous query data, replaces the previous query data with the new query data, and stores the new query data in advance.

9. A method of controlling a hardware accelerator device for deep learning inference, the method comprising:
storing query data, input from a host processor, in input storage;
performing a deep learning operation on the query data stored in the input storage;
determining whether the query data is required in the deep learning operation during the deep learning operation on the query data;
generating a flag, indicating a state in which new query data can be input, when the query data is no longer required in the deep learning operation;
during the deep learning operation, receiving new query data from the host processor that recognizes the flag;
during the deep learning operation, replacing the query data with the new query data and storing the new query data in advance in the input storage;
outputting inference data, which is a result of the deep learning operation on the query data; and
as the inference data, which is the result of the deep learning operation on the query data, is output, performing a deep learning operation on the new query data stored in advance.
